(19) United States
(12) Patent Application Publication
(10) Pub. No.: US 2007/0007731 A1
(43) Pub. Date: Jan. 11, 2007

(54) Double lip dust excluder fork seal

(76) Inventor: Henry W. Zahn, Tulsa, OK (US)

Correspondence Address: HEAD, JOHNSON & KACHIGIAN, 228 W 17TH PLACE, TULSA, OK, 74119, US

(21) Appl. No.: 11/178,988

(22) Filed: Jul. 11, 2005

(51) Int. Cl. F16J 15/32

(52) U.S. Cl. 277/551

(57) ABSTRACT

A double lip seal for a dust excluder seal for a cylindrical reciprocating tube connected to a recreational or utility vehicle, wheel and an off-road motorcycle or bicycle. The seal includes an oil side beam generally parallel to the axis of the reciprocating members and having a spring loaded dust excluder lip for engaging the inner cylindrical tube and wherein the spring is protected from dust and dirt by an outer excluder lip that prevents the garter sprung lip from fouling. In addition the lip is designed with a negative R-value which allows the sprung lip to rotate and position the geometry of the lip to act as a dust excluder lip. The protected spring can now compensate for lip wear which enhances the service life of the seal. The seal also includes an air side beam having a second sealing lip engaging the inner cylindrical tube.

### BACKGROUND OF THE INVENTION

1. Field of the Invention

The present invention relates to seals for a set of reciprocating parts, and more particularly, to seals for shock absorbers which absorb mechanical vibration from road impacts comprising a front wheel suspension of recreational vehicles, such as motorcycles, bicycles and the like.

2. Prior Art

Motorcycles and many bicycles, especially off-road cycles or bikes, have front wheel suspension fork assemblies which include a pair of spaced parallel shock absorbers. Each shock absorber typically comprises a compression spring, an inner tube or shaft connected to the axle of the front wheel and a co-axial, oil-filled outer tube or cylinder connected to the frame of the vehicle and within which the shaft is reciprocable to absorb shocks imparted to the front wheel. Two or more seals are required between the shaft and cylinder for preventing leakage of oil from the cylinder and for preventing entry of air, moisture, dust and dirt into the cylinder. U.S. Pat. No. 6,568,664 to Furuya and U.S. Patent Application Publication U.S. 2003/0019692 A1 to Downes et al. disclose representative examples of prior art seals.

In cycling, dust, mud, water and other debris try to infiltrate the shock absorber. The shock absorber contains air, fluid and a compression spring for proper suspension. If dust and other debris manage to get into the shock absorber, it will increase the wear rate of the fluid seal which will result in premature seal failure. Leakage of fluid will cause the shock absorber to fail.

Accordingly, an object of the invention is to provide a superior dust excluder double lip seal for a pair of reciprocatory members, especially the reciprocable shaft or cylinder of a motorcycle or like shock absorber that will have a long and effective service life.

It is a further object of the invention to provide a dust excluder double lip seal wherein a spring loaded lip is not exposed to dust or the elements.

### SUMMARY OF THE INVENTION

In accordance with the invention, an excluder seal for a shock absorber is comprised of multiple sealing lips. The seal is generally located between the oil side and an airside of the cylinder. The seal is comprised of at least two axially spaced sealing lips for sealingly engaging a shock absorber shaft. The seal further comprises a supporting structure for the lips that causes the internal sprung lip to maintain better followability against the reciprocating shaft. Unlike the current technology, this design has a garter spring with a negative R-value that rotates the sealing lip toward the airside. This garter spring is protected because it is preceded by a rubber excluder sealing lip. In all current fork seal dust lip designs with garter springs the springs are exposed to the environment and become fouled by dirt and debris. An elastomeric excluder lip with a garter spring is unlike an all elastomeric lip in that the spring does not experience stress relaxation. Elastomeric sealing lips go through stress relaxation and can loose up to 40% of their original lip force. The stress relaxation results in a loss of lip force that does not allow the seal to utilize the full wear life of the original interference. The protected garter sprung excluder lip will not foul and therefore maintains a higher lip force and as the seal wears the spring maintains pressure against the shaft, compensating for lip wear and enhancing seal performance and service life. The supporting structure includes a body or mounting portion to be secured to the shock absorber cylinder having a rubber covered metal casing defining a fixed point for the seal, a flange for proper locating, a series of groove to allow air to vent during assembly, a rubber outside diameter for retain and sealing inside the cylinder generally parallel to, i.e., co-axial with, the shaft and the two axially spaced sealing lips. The two lips have interference fit with the shaft. In a preferred embodiment, the sealing lips are provided with a low friction, hard material for engagement with the shaft to reduce the drag force against and along the shaft and with the sprung lip geometry, the negative R-value properly presents the excluder lip to the shaft. Most preferably, the lips are comprised of a low friction, hard and durable elastomer.

In the preferred embodiment, the dust seal is comprised of two sealing lips all shaped and arranged to seal in one direction. The air side of the seal has a excluder lip properly positioned to initially prevent dirt and debris from entering the fork cavity. The second internal sprung excluder lip rotates the lip contact point toward the air side and thereby providing a double lip sealing arrangement. The invention thus provides a greatly improved excluder sealing capable of withstanding the repetitious and extreme environment imposed on the shock absorbers comprising the front wheel forks of cycles, and providing a long seal service life.

These and other objects and advantages of the invention will become apparent to those of reasonable skill in the art from the following detailed description, as considered in conjunction with the accompanying drawings.

### BRIEF DESCRIPTION OF THE DRAWINGS

FIG. 1 is a cross sectional view of a double lip seal constructed in accordance with the present invention shown with an inner cylindrical tube and an existing oil seal;

FIG. 2 is an enlarged view of a cross-sectional view of the excluder seal in FIG. 1; and

FIG. 3 is a perspective view of the seal shown in FIG. 2

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

The following is a detailed description of an embodiment of the invention presently contemplated by the inventor to be the best mode of carrying out his invention.

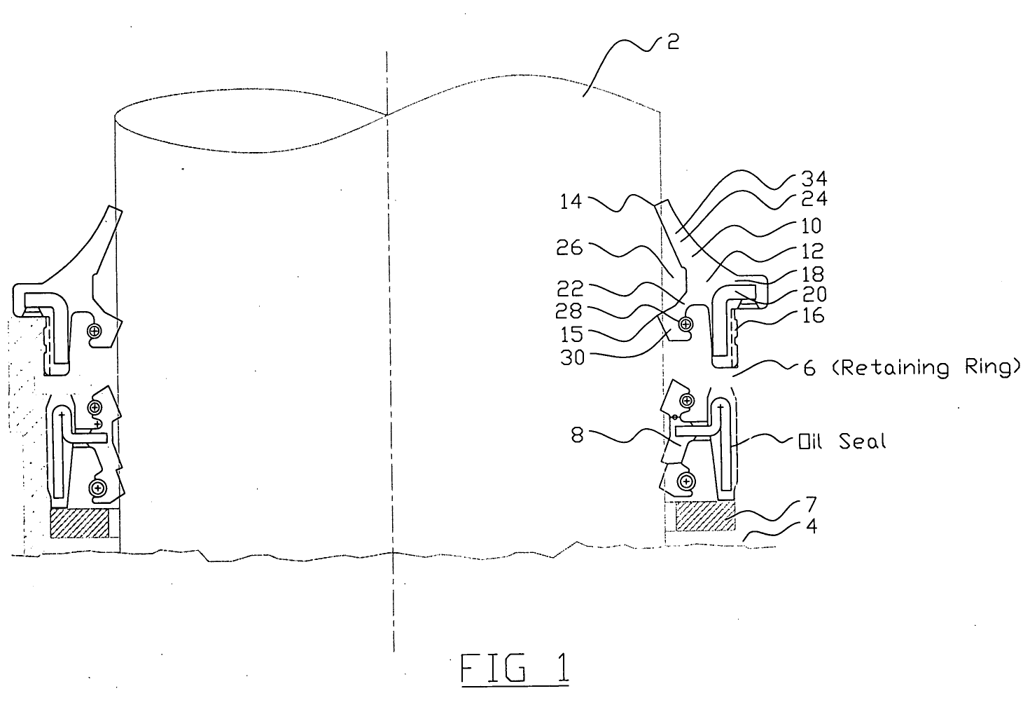

FIG. 1 illustrates a portion of an inner cylinder shaft or tube 2 which moves axially with respect to an outer cylindrical tube 4 (seen in cross-section in FIG. 1). A dust excluder seal 10 of the present invention is juxtaposed between the inner cylindrical tube 2 and outer tube 4. The body 12 of the seal rests against and is supported by the outer tube 4.

The dust excluder seal 10 of the invention is used in combination with a conventional shock absorber oil seal 8, which is known in the art. The oil seal 8 is axially spaced from the oil side of the dust excluder seal 10. The oil seal 8 functions to retain oil in the cavity and the dust excluder seal 10 prevents dirt from entering the oil seal area and in this way preserve the life of the oil seal.

A retaining ring 6 is positioned between the dust excluder seal 10 and the oil seal.

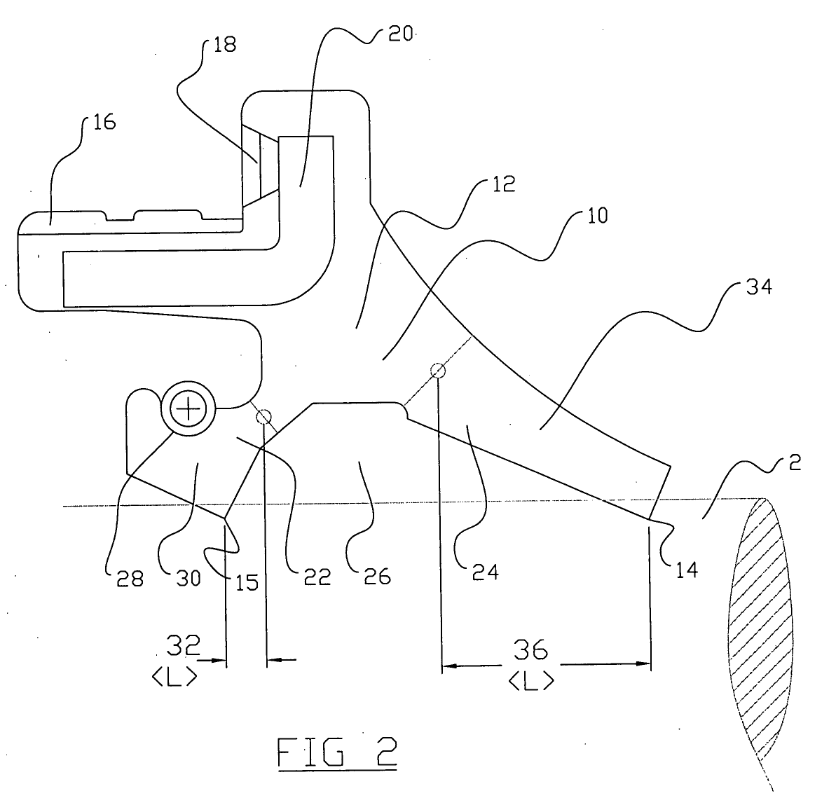

FIG. 2 is a cross-sectional view of an dust excluder seal 10 which is comprised of a body 12 and two sealing portions indicated generally at 14 and 15.

The body 12 comprises an annular ring 16 adapted to be secured to the outer tube 4. The annular ring 16 and a radially extending annular web 18 are reinforced by a metal insert or casing 20 which is relatively rigid.

The casing 20 defines a fixed point from which a pair of annular beams 22 and 24 extend in opposite directions. The beams 22 and 24 extend in directions generally parallel to, i.e., coaxial with the reciprocating members, specifically the inner cylindrical tube 2 of the shock absorber. The beam 22 extends in the direction of the oil cavity of a shock absorber cylinder and the beam 24 extends to an air side.

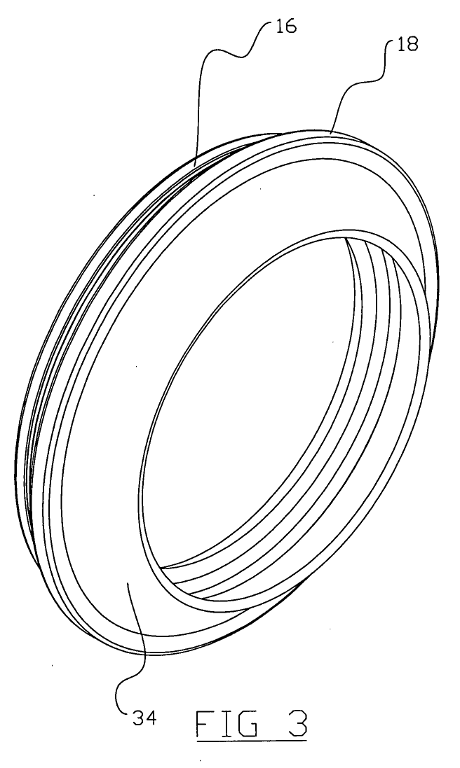

FIG. 2 illustrates an enlarged view of a portion of the seal 10 while FIG. 3 illustrates a perspective view of the device. The oil side beam 22 extends in spaced, generally parallel relation to the annular ring 16 so that an annular chamber 26 is formed between beam 22 and beam 24 which is adapted to be approximately 70% filled with grease prior to installation. An annular coil spring 28 encircles the beam 22 adjacent its free end and biases the beam 22 against the shaft 2.

On a shaft engaging side, the oil side beam 22 is configured to rotate the lip toward the air side and provide two axially spaced dust excluder lips, namely, a first elastomeric sealing lip 30 spaced a first distance or beam length illustrated by arrows 32 from a relatively fixed point defined by the solid rubber area and a second lip 34 spaced a second and greater distance or beam length illustrated by arrows 36 from an axis or flexing point. Both lips are designed to have interference fit with the reciprocating shaft, i.e., each lip at rest before installation has an inner diameter less than the outer diameter of the shaft. When the seal is assembled on the shaft, this interference fit produces a hoop force on the sealing lips in addition to the hydraulic pressure and spring forces.

The oil side dust excluder lips 30 and 34 are preferably comprised of low friction nitrite rubber containing low friction additives such as a % of PTFE, MOS2, and Teflon 7 flake material, to minimize friction drag, improve structurally stability of the beam, and enhance the sealing capability of the lips. Furthermore the oil cavity side beam 22 is configured to define a spring loaded dust excluder lip. The air side lip 34, like the lip 30, has an interference fit with the shaft and has a geometry and position which allows this unique lip to act as a non-binding dust excluder lip.

The coil or garter spring 28 is fully closed prior to assembly onto the fork shaft. The garter spring expands and the coil separate when the dust excluder lip is positioned on the fork. The position of the garter springs on current designs exposes the open coils to dirt and dust. These separations are filled with dirt and therefore prevented from opening and closing of the sealing lip to compensate for seal wear.

It is known that sealing lips must exert a force against the shaft to seal effectively. Dust excluder lip 34 exerts an initial installation lip force. Sealing rubber materials are such that stress relaxation occurs and the lip force is reduced usually within seconds. The dust excluder lip 34 has two components of its geometry that contribute to the initial lip force. The total initial load (prior to stress relaxation) applied to the sealing surface by dust excluder lip 34 includes forces due to rubber hoop forces (F_{R}), and beam deflection (F_{B}). Hoop forces result from the expansion of the seal when it is installed on a shaft, as the inner diameter of the seal lip is typically smaller than the shaft. Beam deflection forces result from the bending moment of the beam, and depend on the beam flex thickness (t), the distance between the lip contact point and the flex point of the beam (L) and the modulus of elasticity of the beam (Ea).

The dust excluder lip 30 exerts an initial installation total load due to rubber hoop forces (FR), beam deflection (FB) and spring tension (FS). The lip contact point of 30 is between the spring centerline and the flex point 22 and rotates the scraper lip towards the air side acting like a sprung dust excluder lip. Spring tension is a radial force applied by the annular spring 28 and depends on spring deflection (F) and the axial distance between the center of the spring and the lip contact point measured axially (Rᵣ).

The standard existing sealing lips to date have a coefficient of friction range of about 0.20˜0.30 while the sealing lips of the present invention has a coefficient of friction range of about 0.15˜0.18. The low friction self-lubricating material reduces friction loading on the seal lips and provide for smooth shaft movement without lip wrap and without seizing or grabbing of the sealing lips on the shaft.

A dust excluder lip in a reciprocating application scrapes the dirt from the shaft and with the proper geometry, spring position and lip rotation the scraper surface is more perpendicular to the shaft.

To impart a long and effective life to the dust excluder seal 10, the geometry of this invention is such that the spring loaded dust excluded lip protects the spring and preserves the action of the garter spring allowing it to compensate for lip wear. The geometry provides a unique negative R− value to rotate the sealing lip toward the air side of the fork and maintain a positive dust excluder lip.

The low friction elastomers play a secondary role of providing smooth fork action without lip warp, stick slip or grabbing.

The objects and advantages of the invention have therefore been shown to be attained in a convenient, practical, economical and facile manner.

While a preferred embodiment of the invention has been herein illustrated and described, it is to be appreciated the various changes, rearrangements and modifications may be made therein without departing from the scope of the invention as defined by the appended claims.

Whereas, the present invention has been described in relation to the drawings attached hereto, it should be understood that other and further modifications, apart from those shown or suggested herein, may be made within the spirit and scope of this invention.

What is claimed is:

1. A dust excluder seal for sealing between a pair of reciprocatory members, adapted to to protect a garter spring and reduce drag friction between a shaft and the seal, which seal comprises:
a sealing portion for sealing engagement with one of the members and a body portion for securement to the other of the members;
said body portion including an annular web for connecting to said sealing portion;
said sealing portion comprising an oil side beam extending in a direction generally parallel to the path of reciprocation of the members and terminating in a lip contact point; and
a second dust excluder lip for engagement with the one member spaced from said first lip.

2. A seal as set forth in claim 1 wherein said one member is an inner cylindrical tube connected to a vehicle wheel and said other member is an outer cylindrical member connected to a vehicle body.

3. A seal as set forth in claim 1 wherein said sealing lips each have an interference fit with the one member.

4. A seal as set forth in claim 1 wherein said oil side beam has a negative R-valve that rotates said lip contact point toward an air side.

5. A seal as set forth in claim 1 including a coil spring bearing on said oil side beam and biasing lip into engagement with the one member.

6. A seal as set forth in claim 5 wherein said beam, the narrowness of said neck, and the biasing force of said coil spring are correlated to maintain lip force and drag against the one member.

7. A seal as set forth in claim 1 wherein said seal is fabricated from nitrile with a low friction rubber additive.

8. A seal as set forth in claim 1 including an air side beam extending in a direction opposite the oil side beam and generally parallel to the path of reciprocation of the members, said air beam terminating in said second dust excluder lip for sealing engagement with the one member at a location spaced from said first lip.

9. A dust excluder seal for sealing between an inner shaft member and a co-axial outer cylinder member reciprocable relative to one another, to withstand a predetermined external pressure, which seal comprises:
an annular sealing portion for sealing engagement with said inner shaft member and an annular body portion for securement to the co-axial cylinder member;
said sealing portion comprising an annular air side beam extending generally parallel to the path of reciprocation of the members;
said air side beam being radially spaced from said body portion and defining an annular chamber therebetween;
said air side beam having a dust excluder lip for engagement with the one member;
said beam having a narrowed neck;
wherein said beam, said lips and said narrowed neck are correlated to adjust lip forces.

10. A seal as set forth in claim 9 wherein said inner shaft member is connected to a vehicle wheel and said outer cylinder member is connected to a vehicle body.

11. A seal as set forth in claim 9 wherein said first and second sealing lips have an interference fit with the one member and the spring of the inner lip is protected by the outer lip.

12. A seal as set forth in claim 9 including an air side beam extending in a direction opposite the oil side beam and generally parallel to the path of reciprocation of the members, said air side beam having at least a second dust excluder lip for sealing engagement with the one member at a location spaced from said first lip.
